(19) United States
(12) Patent Application Publication
(10) Pub. No.: US 2018/0148935 A1
(43) Pub. Date: May 31, 2018

(54) ADAPTIVE TRELLIS SYSTEM

(71) Applicants: Awnex, Inc., Ball Ground, GA (US); The Garrett Company, Ball Ground, GA (US)

(72) Inventor: John F. Dicks, Woodstock, GA (US)

(21) Appl. No.: 15/819,412

(22) Filed: Nov. 21, 2017

Related U.S. Application Data
(60) Provisional application No. 62/427,454, filed on Nov. 29, 2016.
(60) Provisional application No. 62/427,467, filed on Nov. 29, 2016.

(51) Int. Cl. E04F 10/08; F16B 39/04; F16B 39/12

(52) U.S. Cl. CPC E04F 10/08; F16B 39/12; F16B 39/04

(57) ABSTRACT

An adaptable trellis is configured to be affixed to a structure and includes: a plurality of spanning assemblies; at least one inboard assembly; at least one outboard assembly; and at least one tie-back assembly. The at least one tie-back assembly includes an adjustable clevis system configured to adjust the angle of the adaptable trellis system with respect to the structure.

### RELATED APPLICATION(S)

This application claims the benefit of the following U.S. Provisional Application No. 62/427,454, filed on 29 Nov. 2016 and U.S. Provisional Application No. 62/427,467, filed on 29 Nov. 2016, their entire contents of which are herein incorporated by reference.

### TECHNICAL FIELD

This disclosure relates to trellis systems and, more particularly, to easily-adaptable trellis systems.

### BACKGROUND

Trellis systems are utilized on commercial buildings to provide various functionality. For example, these trellis systems may be utilized to shield windows or entryways for sun, to provide protection from rain or snow, or to provide visual appeal. Unfortunately, these trellis systems are often constructed in a bespoke fashion, wherein each trellis system is custom designed for a particular application. For example, various portions of a trellis system may need to be custom configured to provide sun protection functionality, while other portions of the trellis system may need to be custom configured to provide rain/snow protection functionality, while other portions of the trellis system may need to be custom configured to provide neither protection functionality and may simply provide aesthetic functionality.

Accordingly and due to the custom manner in which these trellis systems are designed, the cost of manufacturing such systems and the lead time required for their manufacture are both increased. Further and as these systems are permanently configured when assembled, once they are designed and installed, they can no longer be changed or adapted.

### Summary of Disclosure

Adjustable Clevis System

In one implementation, an adaptable trellis system is configured to be affixed to a structure and includes: a plurality of spanning assemblies; at least one inboard assembly; at least one outboard assembly; and at least one tie-back assembly. The at least one tie-back assembly includes an adjustable clevis system configured to adjust the angle of the adaptable trellis system with respect to the structure.

One or more of the following features may be included. At least two of the spanning assemblies, a portion of the inboard assembly, and a portion of the outboard assembly may form at least one infill panel bay. The at least one infill panel bay may be configured to receive an infill panel assembly. The infill panel assembly may include a sunshade infill panel assembly. The infill panel assembly may include a rain/snow infill panel assembly. The adjustable clevis system may further include a bolt assembly configured to allow for the adjustment of the overall length of the at least one tie-back assembly. The adjustable clevis system may further include a body assembly. The adjustable clevis system may further include a locking nut assembly configured to rotatably position the bolt assembly with respect to the body assembly. The locking nut assembly may include a castle nut assembly. The adjustable clevis system may further include a jamb nut assembly configured to lock the bolt assembly with respect to the tie-back assembly.

In another implementation, an adaptable trellis system is configured to be affixed to a structure and includes: a plurality of spanning assemblies; at least one inboard assembly; at least one outboard assembly; and at least one tie-back assembly. The at least one tie-back assembly includes an adjustable clevis system configured to adjust the angle of the adaptable trellis system with respect to the structure. The adjustable clevis system includes a bolt assembly configured to allow for the adjustment of the overall length of the at least one tie-back assembly and a body assembly.

One or more of the following features may be included. The adjustable clevis system may further include a locking nut assembly configured to rotatably position the bolt assembly with respect to the body assembly. The locking nut assembly may include a castle nut assembly. The adjustable clevis system may further include a jamb nut assembly configured to lock the bolt assembly with respect to the tie-back assembly. At least two of the spanning assemblies, a portion of the inboard assembly, and a portion of the outboard assembly may form at least one infill panel bay. The at least one infill panel bay may be configured to receive an infill panel assembly.

In another implementation, an adaptable trellis system is configured to be affixed to a structure and includes: a plurality of spanning assemblies; at least one inboard assembly; at least one outboard assembly; and at least one tie-back assembly. The at least one tie-back assembly includes an adjustable clevis system configured to adjust the angle of the adaptable trellis system with respect to the structure. The adjustable clevis system includes: a bolt assembly configured to allow for the adjustment of the overall length of the at least one tie-back assembly, a body assembly, a locking nut assembly configured to rotatably position the bolt assembly with respect to the body assembly, and a jamb nut assembly configured to lock the bolt assembly with respect to the tie-back assembly.

One or more of the following features may be included. The locking nut assembly may include a castle nut assembly. At least two of the spanning assemblies, a portion of the inboard assembly, and a portion of the outboard assembly may form at least one infill panel bay. The at least one infill panel bay may be configured to receive an infill panel assembly.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an adaptable trellis system according to an embodiment of the present disclosure;

FIG. 2A is a diagrammatic view of a sunshade infill panel assembly for use within the adaptable trellis system of FIG. 1;

FIG. 2B is a diagrammatic view of a rain/snow infill panel assembly for use within the adaptable trellis system of FIG. 1;

FIG. 3 is a diagrammatic view of a tie-back assembly for use with the adaptable trellis system of FIG. 1;

FIG. 4 is an isometric view of an adjustable clevis system for use with the tie-back assembly of FIG. 3;

FIG. 5A is a side view of the adjustable clevis system of FIG. 4;

FIG. 5B is a top view of the adjustable clevis system of FIG. 4; and

FIG. 5C is a cross-sectional view of the adjustable clevis system of FIG. 4.

Like reference symbols in the various drawings indicate like elements.

### DETAILED DESCRIPTION OF THE PREFERRED EMBODIMENTS

System Overview

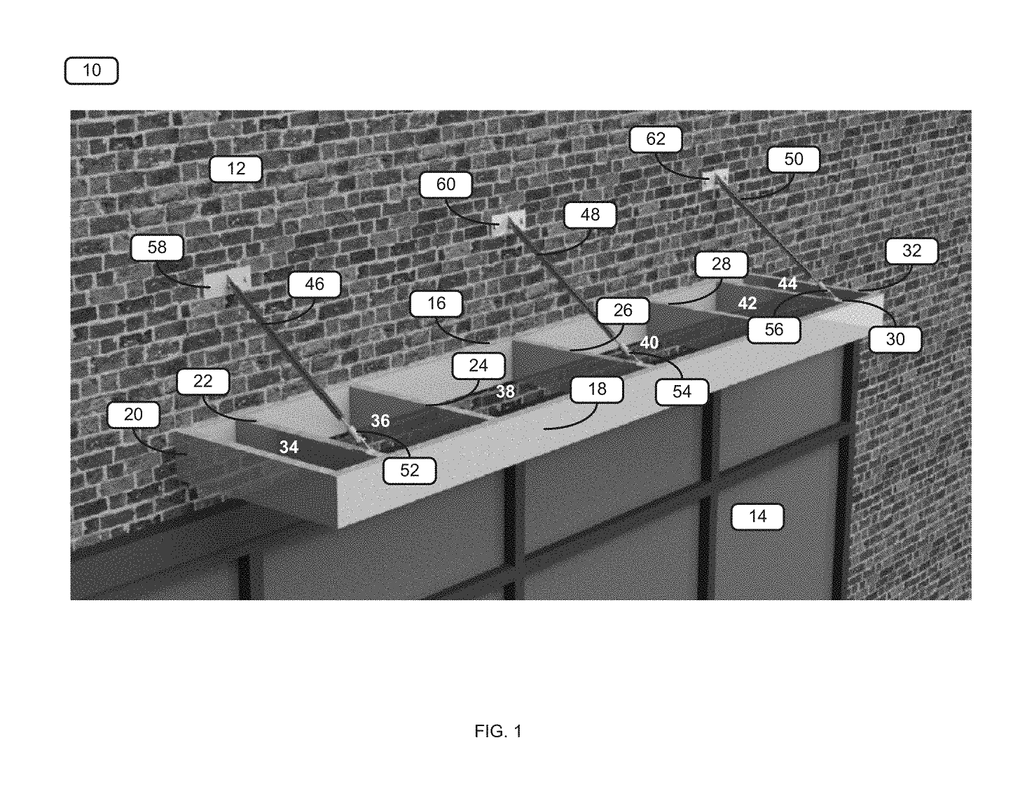

Referring to FIG. 1, there is shown adaptable trellis system 10 that may be configured to be attached to a structure (e.g., structure 12). Examples of structure 12 may include but are not limited to residential structures and commercial structures. Further, adaptable trellis system 10 may be configure to be positioned proximate various portions of structure 12, examples of which may include but are not limited to: windows (e.g., window 14); entryways (not shown); stair systems (not shown), electrical systems (not shown); mechanical systems (not shown); and other systems for which shielding from the elements may be desirable.

Adaptable trellis system 10 may include inboard assembly 16 (wherein inboard assembly 16 may be rigidly affixed to structure 12) and outboard assembly 18 (wherein outboard assembly 18 may be spaced away from inboard assembly 16 by a plurality of spanning assemblies (e.g., spanning assemblies 20, 22, 24, 26, 28, 30, 32). While FIG. 1 is shown to include seven spanning assemblies (e.g., spanning assemblies 20, 22, 24, 26, 28, 30, 32), this is for illustrative purposes only and is not intended to be a limitation of this disclosure, as other configurations are possible and are considered to be within the scope of this disclosure. For example, the number of spanning assemblies may be increased or decreased depending upon the size and design criteria of adaptable trellis system 10.

The spanning assemblies (e.g., spanning assemblies 20, 22, 24, 26, 28, 30, 32), inboard assembly 16 and/or outboard assembly 18 may be constructed of various types of components, examples of which may include but are not limited to round tube, square tube and rectangular tube materials formed of various materials, such as metal (e.g., aluminum or steel) or plastic (e.g., ABS, fiberglass or carbon fiber composite).

The spanning assemblies (e.g., spanning assemblies 20, 22, 24, 26, 28, 30, 32) in combination with portions of inboard assembly 16 and outboard assembly 18 may form a plurality of infill panel bays into which various infill panels may be placed. For example:
spanning assemblies 20, 22, a portion of inboard assembly 16 and a portion of outboard assembly 18 may form infill panel bay 34;
spanning assemblies 22, 24, a portion of inboard assembly 16 and a portion of outboard assembly 18 may form infill panel bay 36;
spanning assemblies 24, 26, a portion of inboard assembly 16 and a portion of outboard assembly 18 may form infill panel bay 38;
spanning assemblies 26, 28, a portion of inboard assembly 16 and a portion of outboard assembly 18 may form infill panel bay 40;
spanning assemblies 28, 30, a portion of inboard assembly 16 and a portion of outboard assembly 18 may form infill panel bay 42; and
spanning assemblies 30, 32, a portion of inboard assembly 16 and a portion of outboard assembly 18 may form infill panel bay 44.

Adaptable trellis system 10 may be supported by one or more tie-back assemblies (e.g., tie-back assemblies 46, 48, 50). While FIG. 1 is shown to include three tie-back assemblies (e.g., tie-back assemblies 46, 48, 50), this is for illustrative purposes only and is not intended to be a limitation of this disclosure, as other configurations are possible and are considered to be within the scope of this disclosure. For example, the number of tie-back assemblies may be increased or decreased depending upon the size and design criteria of adaptable trellis system 10.

Each of tie-back assemblies 46, 48, 50 may include an adjustable clevis system (e.g., adjustable clevis system 52, 54, 56, respectively) that may effectuate the coupling of a first distal end of the tie-back assemblies to one of the spanning assemblies (e.g., spanning assemblies 22, 26, 30, respectively) or to outboard assembly 18 of adaptable trellis system 10. A second distal end of each of tie-back assemblies 46, 48, 50 may be coupled to a bracket assembly (e.g., bracket assembly 58, 60, 62) that is rigidly affixed to structure 12.

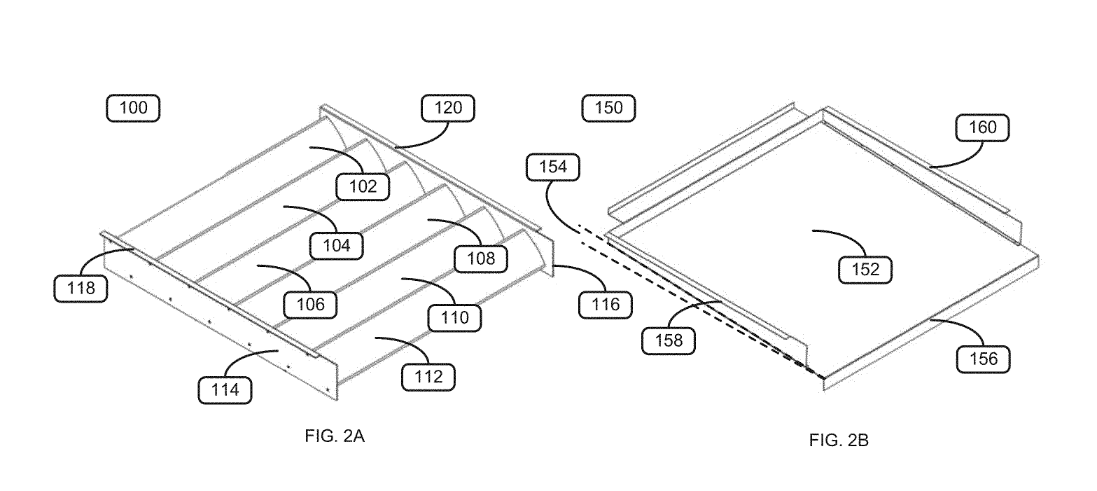

Referring also to FIGS. 2A-2B, there are shown various and illustrative examples of infill panel assemblies that may be releasably positionable within one or more of the infill panel bays (e.g., infill panel bays 34, 36, 38, 40, 42, 44), wherein infill panel bays 34, 36, 38, 40, 42, 44 may come in standardized sizes. For example, certain infill panel bays (e.g., infill panel bays 38, 40) may be full size infill panel bays (configured to receive full size infill panel assemblies), while other infill panel bays (e.g., infill panel bays 36, 42) may be half size infill panel bays (configured to receive half size infill panel assemblies), and other infill panel bays (e.g., infill panel bays 34, 44) may be quarter size infill panel bays (configured to receive quarter size infill panel assemblies).

Specifically referring to FIG. 2A, there is shown sunshade infill panel assembly 100 that may be sized to be releasably received within one or more of the full size infill panel bays (e.g., infill panel bays 38, 40), one or more of the half size infill panel bays (e.g., infill panel bays 36, 42), or one or more of the quarter size infill panel bays (e.g., infill panel bays 34, 44).

Sunshade infill panel assembly 100 may include a plurality of sun blocking elements (e.g., sun blocking elements 102, 104, 106, 108, 110, 112) that may be angled with respect to (and fastened to) connector assemblies 114, 116. Connector assemblies 114, 116 may include flange assemblies 118, 120 (respectively) that may be configured to releasably engage corresponding surfaces (e.g., an upper surface of one or more of spanning assemblies 20, 22, 24, 26, 28, 30, 32, inboard assembly 16 and/or outboard assembly 18). Sunshade infill panel assembly 100 may be constructed of various materials, such as metal (e.g., aluminum or steel) or plastic (e.g., ABS, fiberglass or carbon fiber composite).

Specifically referring to FIG. 2B, there is shown rain/snow infill panel assembly 150 that may be sized to be releasably received within one or more of the full size infill panel bays (e.g., infill panel bays 38, 40), one or more of the half size infill panel bays (e.g., infill panel bays 36, 42), or one or more of the quarter size infill panel bays (e.g., infill panel bays 34, 44).

Rain/snow infill panel assembly 150 may include a deflection surface (e.g., deflection surface 152) that may be angled (e.g., at angle 154) so as to direct rain water and/or snow melt toward drip edge 156. While in this particular implementation, drip edge 156 is shown to direct the rain water and/or snow melt toward outboard assembly 18, this is for illustrative purposes only and is not intended to be a limitation of this disclosure, as other configurations are possible and are considered to be within the scope of this disclosure. For example, drip edge 156 may also be positioned proximate inboard assembly 16. Regardless of the position (inboard or outboard) of drip edge 156, the rain water and/or the snow melt may be directed toward a gutter system (not shown) that may be configured to collect the rain water and/or snow melt and direct the same toward a downspout system (not shown) that directs the water away from structure 12.

Rain/snow infill panel assembly 150 may include flange assemblies 158, 160 that may be configured to releasably engage corresponding surfaces (e.g., an upper surface of one or more of spanning assemblies 20, 22, 24, 26, 28, 30, 32, inboard assembly 16 and/or outboard assembly 18). Rain/snow infill panel assembly 150 may be constructed of various materials, such as metal (e.g., aluminum or steel) or plastic (e.g., ABS, fiberglass or carbon fiber composite).

Other examples of infill panel assemblies that may be releasably positionable within one or more of the infill panel bays (e.g., infill panel bays 34, 36, 38, 40, 42, 44) may include but are not limited to solid infill panel assemblies (not shown) that are designed to prevent the passage of light through the infill panel bay, and perforated infill panel assemblies (not shown) that are designed to allow the passage of some light through the infill panel bay.

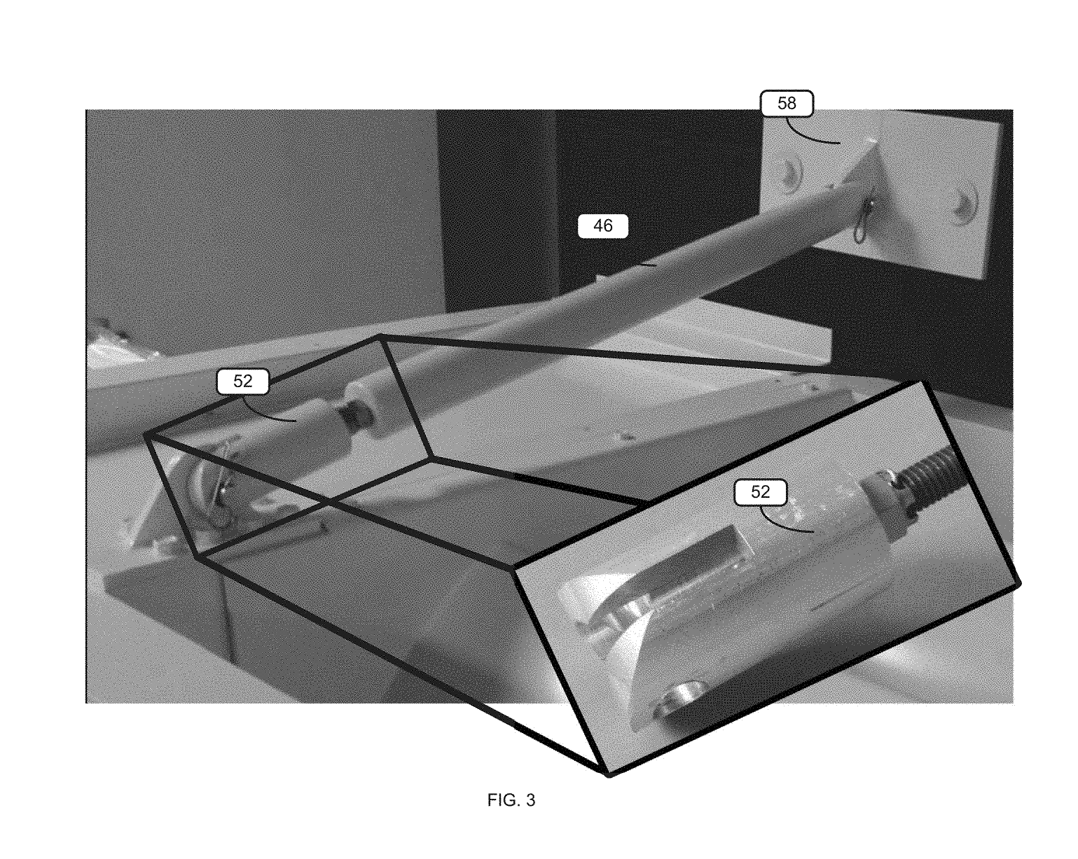

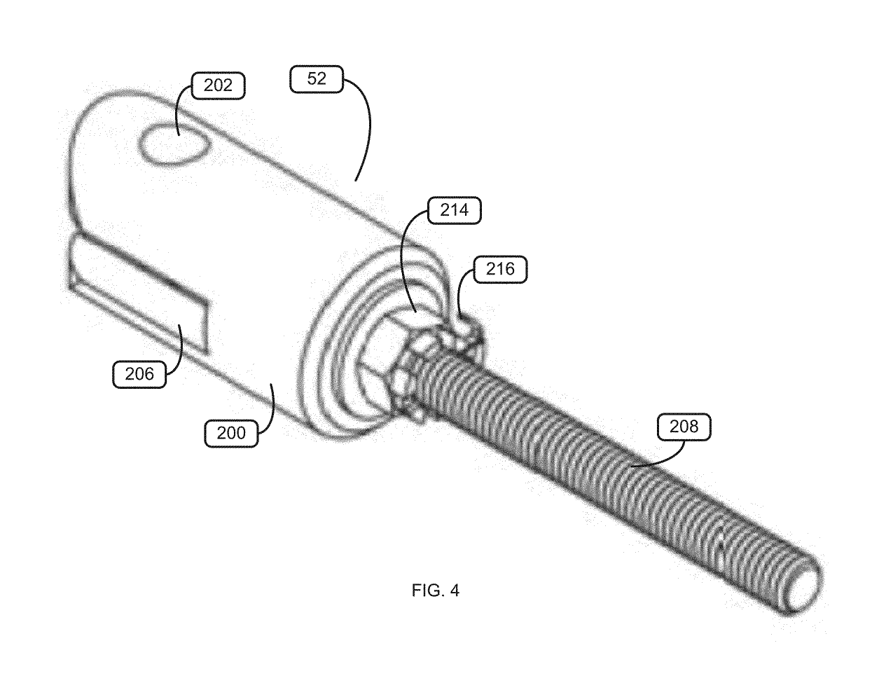

As discussed above, adaptable trellis system 10 may be supported by one or more tie-back assemblies (e.g., tie-back assemblies 46, 48, 50), wherein each of tie-back assemblies 46, 48, 50 may include an adjustable clevis system (e.g., adjustable clevis system 52, 54, 56, respectively). Referring also to FIGS. 3-4, there is shown an isometric view of such an adjustable clevis system. While in this particular example, adjustable clevis system 52 is discussed, it is understood that the following illustrative example may concern any of adjustable clevis systems 52, 54, 56.

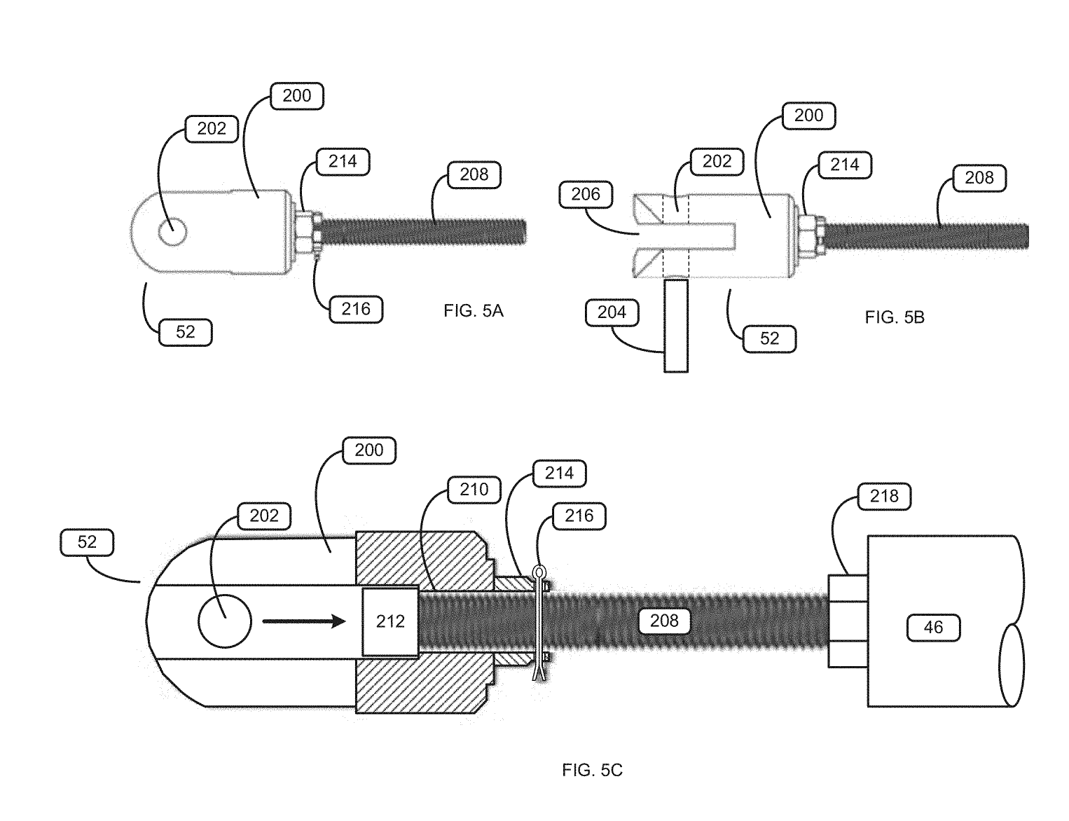

Referring also to FIGS. 5A, 5B and 5C, there is shown a side view of the adjustable clevis system 52 (in FIG. 5A), a top view of adjustable clevis system 52 (in FIG. 5B), and a cross-sectional view of adjustable clevis system 52 (in FIG. 5C).

Adjustable clevis system 52 may include body assembly 200, which may be constructed out of various materials, such as metal (e.g., aluminum or steel) or plastic (e.g., ABS, fiberglass or carbon fiber composite). Body assembly 200 may include passage 202 through which a pin assembly or a bolt assembly (e.g., fastener assembly 204) may be utilized to releasable couple adjustable clevis system 52 to a bracket assembly (not shown) coupled to one or more of spanning assemblies 20, 22, 24, 26, 28, 30, 32 or outboard assembly 18. Body assembly 200 may further include slot assembly 206 configured to receive the bracket assembly (not shown) coupled to one or more of spanning assemblies 20, 22, 24, 26, 28, 30, 32 or outboard assembly 18.

Adjustable clevis system 52 may include bolt assembly 208 that is configured to pass through and extend out of body assembly 202. Bolt assembly 208 may be constructed out of various materials, such as stainless steel. Body assembly 202 may include passage 210 that may be positioned along a longitudinal axis of body assembly 202 and configured to receive bolt assembly 208. Passage 210 may include a recess configured to receive a head assembly head (e.g., head assembly 212) of bolt assembly 208. An example of bolt assembly 208 may include but is not limited to an Allen bolt assembly and head assembly 212 may be configured to receive an Allen key or Allen driver. Bolt assembly 208 may be rotatably positioned with respect to body assembly 202 via locking nut assembly 214. Examples of locking nut assembly 214 may include but are not limited to: a nylon insert locknut assembly; a double nut locking assembly; and a castle nut assembly that may be locked into position via a cotter pin assembly (e.g., cotter pin assembly 216).

Bolt assembly 208 may be configured to threadably engage tie-back assembly 46. Through the use of locking nut assembly 214, bolt assembly 208 may be rotated with respect to body assembly 202, thus allowing bolt assembly 208 to be threaded into (or threaded out of) tie-back assembly 46, thus shortening (or lengthening) the overall length of tie-back assembly 46 and allowing the angle of adaptable trellis system 10 (with respect to structure 12) to be adjusted i.e., from sloping away from structure 12, through being perpendicular to structure 12, to sloping toward structure 12. Once adaptable trellis system 10 is properly positioned (i.e., angled) with respect to structure 12, this angle may be locked in by tightening jamb nut 218 (which is threaded onto bolt assembly 202) against tie-back assembly 46.

General:

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. An adaptable trellis system, configured to be affixed to a structure, comprising:
a plurality of spanning assemblies;
at least one inboard assembly;
at least one outboard assembly; and
at least one tie-back assembly, wherein the at least one tie-back assembly includes:
an adjustable clevis system configured to adjust the angle of the adaptable trellis system with respect to the structure.

2. The adaptable trellis system of claim 1 wherein at least two of the spanning assemblies, a portion of the inboard assembly, and a portion of the outboard assembly form at least one infill panel bay.

3. The adaptable trellis system of claim 2 wherein the at least one infill panel bay is configured to receive an infill panel assembly.

4. The adaptable trellis system of claim 3 wherein the infill panel assembly includes:
a sunshade infill panel assembly.

5. The adaptable trellis system of claim 3 wherein the infill panel assembly includes:
a rain/snow infill panel assembly.

6. The adaptable trellis system of claim 1 wherein the adjustable clevis system further includes:
a bolt assembly configured to allow for the adjustment of the overall length of the at least one tie-back assembly.

7. The adaptable trellis system of claim 6 wherein the adjustable clevis system further includes:
a body assembly.

8. The adaptable trellis system of claim 7 wherein the adjustable clevis system further includes:
a locking nut assembly configured to rotatably position the bolt assembly with respect to the body assembly.

9. The adaptable trellis system of claim 8 wherein the locking nut assembly includes:
a castle nut assembly.

10. The adaptable trellis system of claim 6 wherein the adjustable clevis system further includes:
a jamb nut assembly configured to lock the bolt assembly with respect to the tie-back assembly.

11. An adaptable trellis system, configured to be affixed to a structure, comprising:
a plurality of spanning assemblies;
at least one inboard assembly;
at least one outboard assembly; and
at least one tie-back assembly, wherein the at least one tie-back assembly includes:
an adjustable clevis system configured to adjust the angle of the adaptable trellis system with respect to the structure, wherein the adjustable clevis system includes:
a bolt assembly configured to allow for the adjustment of the overall length of the at least one tie-back assembly, and
a body assembly.

12. The adaptable trellis system of claim 11 wherein the adjustable clevis system further includes:
a locking nut assembly configured to rotatably position the bolt assembly with respect to the body assembly.

13. The adaptable trellis system of claim 12 wherein the locking nut assembly includes:
a castle nut assembly.

14. The adaptable trellis system of claim 11 wherein the adjustable clevis system further includes:
a jamb nut assembly configured to lock the bolt assembly with respect to the tie-back assembly.

15. The adaptable trellis system of claim 11 wherein at least two of the spanning assemblies, a portion of the inboard assembly, and a portion of the outboard assembly form at least one infill panel bay.

16. The adaptable trellis system of claim 15 wherein the at least one infill panel bay is configured to receive an infill panel assembly.

17. An adaptable trellis system, configured to be affixed to a structure, comprising:
a plurality of spanning assemblies;
at least one inboard assembly;
at least one outboard assembly; and
at least one tie-back assembly, wherein the at least one tie-back assembly includes:
an adjustable clevis system configured to adjust the angle of the adaptable trellis system with respect to the structure, wherein the adjustable clevis system includes:
a bolt assembly configured to allow for the adjustment of the overall length of the at least one tie-back assembly,
a body assembly,
a locking nut assembly configured to rotatably position the bolt assembly with respect to the body assembly, and
a jamb nut assembly configured to lock the bolt assembly with respect to the tie-back assembly.

18. The adaptable trellis system of claim 17 wherein the locking nut assembly includes:
a castle nut assembly.

19. The adaptable trellis system of claim 17 wherein at least two of the spanning assemblies, a portion of the inboard assembly, and a portion of the outboard assembly form at least one infill panel bay.

20. The adaptable trellis system of claim 19 wherein the at least one infill panel bay is configured to receive an infill panel assembly.
